(19) United States
(12) Patent Application Publication
(10) Pub. No.: US 2008/0111519 A1
(43) Pub. Date: May 15, 2008

(54) Hybrid automotive vehicle with closed-circuit battery charging

(76) Inventor: Michael M. Vasilantone, Bayonne, NJ (US)

Correspondence Address: Charles I. Brodsky, Esq., 2 Bucks Lane, Marlboro, NJ, 07746, US

(21) Appl. No.: 11/598,285

(22) Filed: Nov. 13, 2006

(51) Int. Cl. H02J 7/00; B60K 6/00; B60K 6/28

(52) U.S. Cl. 320/109; 180/65.2; 903/907

(57) ABSTRACT

A male coupler at an outside location of a hybrid automotive vehicle joins with a female coupler at a nesting site where the vehicle parks, and is there connected to an underground source of charging power for the vehicle's battery.

### CROSS-REFERENCE TO RELATED APPLICATIONS

None

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not applicable

### BACKGROUND OF THE INVENTION

1. Field of the Invention

This invention relates to hybrid automotive vehicles combining electric motors and generators with combustion engines, in general, and to a hybrid automotive vehicle in which closed-circuit battery charging is automatically achievable without operator involvement in parking, in particular.

2. Description of the Related Art

As is well known and understood, automotive manufacturers are either producing or developing automobiles with hybrid engines which combine electrical power with internal combustion engines. In these designs, the generator constantly charges the vehicle's batteries, while increasing revolutions during moments of deceleration increases the charging of the batteries and the braking forces applied to the drive shaft. There, the electric motor always assists the engine during vehicle acceleration, but at the same time always senses the drive shaft load in reacting on demand; in these configurations, the electric motor also acts as a primary driver in preventing battery over-charge.

### SUMMARY OF THE INVENTION

As will become clear from the following description, the present invention may operate in a system which combines an electric motor and generator with a rotary combustion engine. As will be understood, the engine may utilize a rotary internal combustion engine which incorporates features of my prior U.S. Pat. No. 3,971,347 (issued Jul. 27, 1976), U.S. Pat. No. 4,307,695 (issued Dec. 29, 1981), and U.S. Pat. No. 6,698,395 (issued Mar. 2, 2004)—and of my pending U.S. patent application Ser. No. 10/818,853, filed Apr. 7, 2004 (Publication No. US-2005-0224263, published Oct. 13, 2005), now Patent No.

a) My patent, U.S. Pat. No. 3,971,347 describes a rotary internal combustion engine housing and a concentrically arranged chamber within the housing in receiving an eccentrically disposed cylindrical rotor; the rotor cooperates with the chamber to define a crescent-shaped chamber which is sequentially divided into intake, compression, combustion and exhaust chambers by means of vanes which are pivotally mounted on the annular surface of the rotor and which engage the inner surface of the housing in defining the chamber. The resulting configuration provides efficiency of operation, effective sealing between the rotor and the housing, effective minimalization of heat build up due to frictional contact, and a great rigidity and strength.

b) My second patent, U.S. Pat. No. 4,307,695 provides enhanced operation by having a blower and/or superchargers that are driven by the rotary engine. The design includes a rotor, a plurality of pistons angularly mounted in the rotor, an actuator mounted for eccentric rotation relative to the access of rotation of the rotor, a blower, a transverse actuator pin connecting each piston to the actuator, and a plurality of fixed pins connecting the rotor to the actuator. With the fixed pins mounted on the rotor so as to pass through clearance holes in the blower in carrying extension gears which mate with internal gears mounted in the actuator, rotation of the rotor causes rotation of the blower and of the actuator as well. As there set forth, the rotational force that results changes the pressure line in its direction, moving it towards the direction of rotation as the rotational speed increases.

c) My third patent, U.S. Pat. No. 6,698,395 describes a hybrid engine that includes the basic configuration of my U.S. Pat. No. 4,307,695 patent—but, instead of employing its pistons, utilizes the pivoting vane concept of my U.S. Pat. No. 3,971,347 patent albeit somewhat modified. Also, in so doing, the blower and supercharger of my later design is eliminated—leading to the end result of a very small engine yet with a comparable amount of power as with hybrid engines utilizing standard cylinder engines. This hybrid engine includes an electric generator, an electric motor, and a rotary internal combustion engine that includes pivoted vane elements mounted on a rotor and biased into engagement to sequentially form intake, compression, combustion and exhaust chambers between the rotor and its annular wall.

d) My pending application Ser. No. 10/818,853 describes the hybrid portion of the rotary engine being modified to include a translator element connected to an electric clutch-brake within the generator component, an operator vertical control lever, and a central programmable control module. Such modifications allow for the elimination and replacement of the steering wheel and foot pedals of the conventional vehicle, an increased charging by the generator, and an increased braking of the drive shaft when necessary. The end result will be an increase in fuel efficiency and an increase in operator efficiency. At the same time the arrangement allows a rotary engine which employs no transmission whatsoever, within a power module containing three major components: an engine, an electric motor, and a generator system all mounted on one common drive shaft.

As will be appreciated by those skilled in the art, the teachings of the present invention are applicable not only to these hybrid rotary internal combustion engines but to all hybrid engines in which battery employment is utilized in the operation of the vehicle. In a first version of the invention to be described, closed circuit battery charging is utilized automatically upon parking the vehicle without individual operator involvement. In a second version of the invention, solar battery charging during daylight hours is automatically provided by means of electrical generating solar elements provided in the vehicle's paint finish

More specifically, the first version of the invention embodies teachings similar to those employed in closed-circuit aircraft refueling employing probe-and-drogue methods. There, an aircraft that needs to refuel extends a device (probe) that is inserted into the center of a cone-shaped basket component known (drogue) at the end of a long flexible hose which is unreeled from behind and below the tanker aircraft. In accordance with the present invention, a male coupler at an outside location of the vehicle joins with a female coupler at a nesting site where the vehicle parks, and is there connected to an underground source of charging power for the vehicle's battery. In this manner, whenever the vehicle is to be parked in a garage or in a parking lot, automatic recharging of the battery occurs. Whether parking in one's own garage, or at a school, or at a supermarket parking lot, or at some other parking space, the closed-circuit which results automatically starts the re-charging of the hybrid vehicle's battery. (As will also be appreciated, the locations of the male and female couplers could be reversed, however.)

In the second version of the invention, semiconductor bits, ultraviolet-light photons or nanocrystals are formulated with a polythiophene conductive polymer in a paint resin for the outer surface of the vehicle to gather energy as a large solar collector. Analysis has shown this to be far more effective than just mounting solar cells at various locations on the vehicle's bodywork.

As will be understood, whether the teachings of the present invention are employed with the hybrid engines of my previous described designs, or with those of others, the net result will continue to be a significant reduction in the use of gasoline in vehicular transportation.

### BRIEF DESCRIPTION OF THE DRAWINGS

These and other features of the present invention will be more clearly understood from a consideration of the following description, taken in connection with the accompanying drawings in which:

FIG. 1 is a pictorial illustration of a preferred location for the male coupler of the closed-circuit battery charging version of the invention;

FIG. 2 is a schematic diagram helpful in an understanding of the manner by which the coupler of FIG. 1 initiates a feed from an underground electrical power source to the storage batteries of the vehicle; and

FIG. 3 is a depiction helpful in understanding how a painted outside surface of the vehicle is able to provide efficient electrical solar energy to its included storage batteries.

### DETAILED DESCRIPTION OF THE INVENTION

As an alternative to simply providing a supply cord from an electric outlet in charging the storage batteries of hybrid automotive vehicle overnight, the present invention provides a continuous trickle charge if and as needed automatically once the vehicle is parked. As will be appreciated, the closed-circuit battery charging system of the invention can be installed in almost any facility—such as at a parking spot in a supermarket, mall or motel parking lot, on a street adjacent parking meters, or at any private garage parking (whether at home or away).

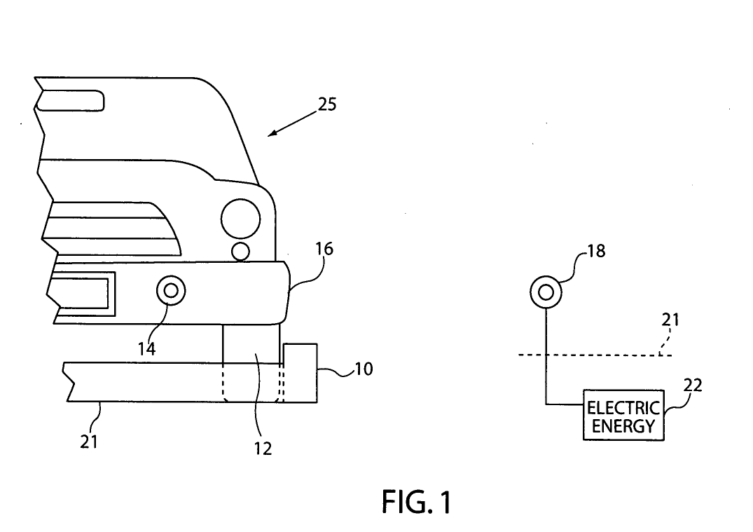

FIG. 1, according to the invention, shows a partial front view of a hybrid automotive vehicle 25 along with a tire nest 10 for its driver's side front wheel 12. A male coupler 14 is included on the front bumper 16 to align with a female coupler 18 when so nested, with the female coupler 18 then being connected to a source of electrical energy under ground 21, as at 22. In accordance with the invention, aligning the wheel 12 with the nest 10 then mates the two couplers together so that the underground electrical power can charge the storage batteries of the hybrid vehicle. As will be appreciated, such vehicle is of a type including a gasoline engine, an energy storage fuel tank device for the engine, an electric motor, energy storage device batteries for the motor, and a generator—all interacting to draw energy from the batteries when the vehicle is accelerated, and returning energy to the batteries when the vehicle is slowed, in known manner.

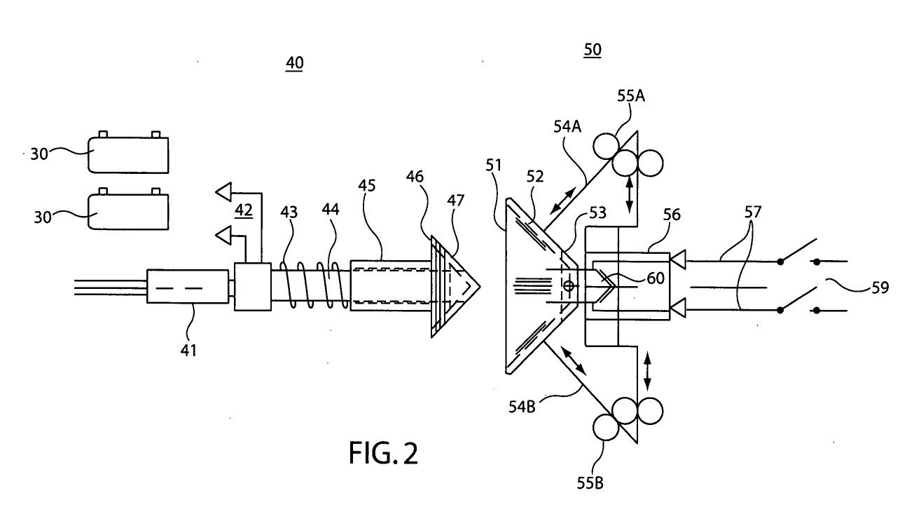

The storage batteries for the hybrid vehicle is shown at 30 in FIG. 2, the male coupler on the vehicle is shown at 40, and the female coupler is shown at 5.0. In particular, the male coupler 40 includes a solenoid 41, a set of connections 42 for the batteries 30, a compression spring 43 and an electrical plug 44. A tubular guide 45 aligns the plug 44 with a bumper cap 46 together with an external concentric sensor 47. As will be appreciated, the components 41-47 essentially comprise, and are represented by, the male coupler 14 of FIG. 1.

Following through on the probe-and-drogue method of aircraft refueling, the female coupler 50 of FIG. 2 incorporates a dish 51 having a set of internal sensors 52 to recognize the insertion of the concentric sensor 47 of the male coupler 40. A universal 53 mounts with the dish 51 (which is preferably spring-loaded) to tilt the dish 51 in automatically centering the sensor 47 once physical contact is made. A further, included track tilt 54 (A and B) and track drive 55 (A & B) provides the central alignment in well known manner to ensure the seating of the concentric sensor 47 with the dish 51.

Once the alignment is achieved, the male plug 44 seats into a receptacle 56 (as illustrated at 60) and the source connection 57 automatically energizes the solenoid 41 from the underground electrical energy source 59. The recharge of the batteries 30 then automatically follows.

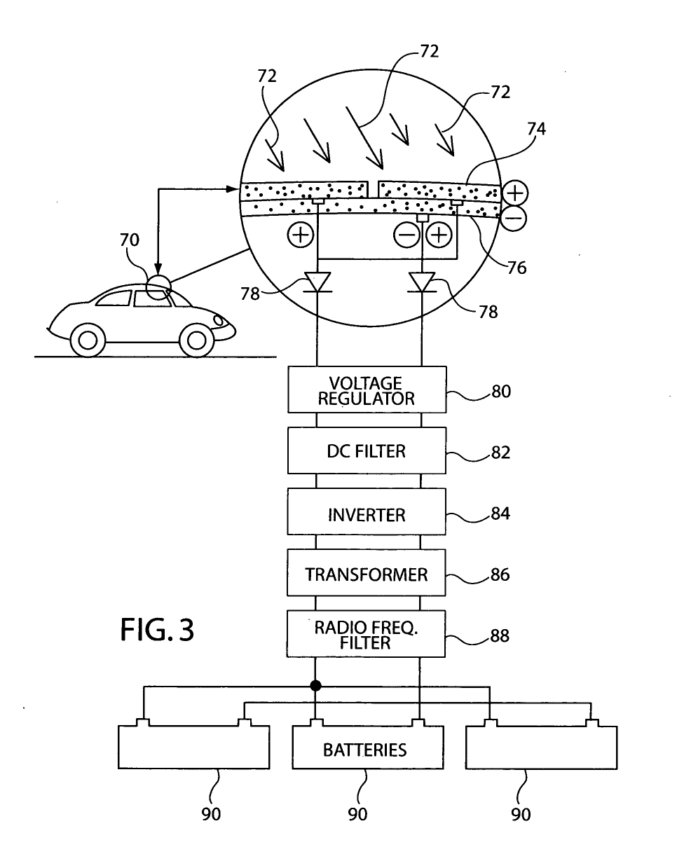

As will be appreciated by those skilled in the art, the solar battery charging arrangement of the invention shown in FIG. 3 can operate with the closed-circuit battery charging of FIGS. 1 and 2, or separate from it. With solar energy being substantially free, clean and inexhaustible, solar battery charging can occur according to the invention when the automotive vehicle includes an outer paint resin finish which includes individual ones of semi-conductive bits, ultra-violet photons or nanocrystals in a polythiophene conductive polymer. One composition for this includes the conductive, photosensitive polymer MEH-PPY with lead selenide quantum dots. In particular, under visible light, a finish incorporating these dots at only 5 percent by weight generates 50 percent more current than expected, and with an 8-nanometer-diameter lead selenide crystal provides quite acceptable results. Incorporated as a paint resin to form the outer painted surfaces of the vehicle, a surface of the type described gathers energy as a large solar collector and a channelable converter directly to the vehicle's batteries. In FIG. 3, the spray painted surface 70 is shown at the roof of the vehicle, in which the light photons 72 strike the P-type layers 74, in which the underlying N-type layers 76 couple through a pair of blocking diodes 78 through a voltage regulator 80, a DC filter 82, an inverter 84, a transformer 86, and a radio frequency filter 88 to the various batteries 90 as may be utilized in the hybrid vehicle.

Analysis has shown that with either version of the invention described above, the reduction of fuel to electricity ratio to power the vehicle can be established at some 25 percent, rather than at close to 100 percent with present modern day vehicles.

While there have been described what are considered to be preferred embodiments of the present invention, it will be readily understood that modifications can be made without departing from the scope of the teachings herein. For at least such reason, therefore, resort should be had to the claims appended hereto for a true understanding of the invention.

I claim:

1. A closed-circuit battery charging system comprising:
an underground source of electrical energy providing electrical power at one of a female and male connector located above ground;
a hybrid automotive vehicle having a gasoline engine, an energy storage device fuel tank for the engine, an electric motor, energy storage batteries for the motor, and a generator, all interacting for the electric motor to draw energy from the batteries when accelerating the vehicle, and to return energy to the batteries when slowing the vehicle;
one of a male and female connector on the vehicle positioned to mate with the above ground connector of said electrical energy source when parked;
and means within the vehicle coupled between the connector on the vehicle and the batteries thereof to automatically begin charging the batteries when the vehicle is positionally parked to mate with the above ground connector.

2. The closed-circuit battery charging system of claim 1 in which a male connector on the vehicle is located to mate with an above ground female connector of the electrical energy source.

3. The closed-circuit battery charging system of claim 2 wherein the male connector on the vehicle is located on a front bumper of the vehicle.

4. The closed-circuit battery charging system of claim 1 wherein said male connector is included on said vehicle adjacent a front tire thereof.
